(19) United States
(12) Patent Application Publication
(10) Pub. No.: US 2009/0228700 A1
(43) Pub. Date: Sep. 10, 2009

(54) Internet Gatekeeper Protocol

(75) Inventor: John F. Hubbell, Houston, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/398,306

(22) Filed: Mar. 5, 2009

Related U.S. Application Data
(60) Provisional application No. 61/034,355, filed on Mar. 6, 2008.

(51) Int. Cl. H04L 9/00; H03M 13/09; G06F 11/10

(52) U.S. Cl. 713/153; 714/799; 714/E11.032

(57) ABSTRACT

According to one embodiment, a computerized method includes receiving encrypted user data and encrypted gatekeeper header data from a sender appliance. The encrypted user data is encrypted according to a receiver encrypting key. The encrypted gatekeeper header data is encrypted according to a gatekeeper encrypting key. A receiver address is identified by decrypting the encrypted gatekeeper header data according to a gatekeeper decrypting key. Encrypted receiver header data is generated by a computer according to the receiver encrypting key. The encrypted user data and encrypted receiver header data are transmitted to a receiver appliance according to the identified receiver address.

### CROSS-REFERENCE TO RELATED APPLICATIONS

This application claims the benefit of priority under 35 U.S.C. §119(e) of U.S. Provisional Patent Application Ser. No. 61/034,355 entitled “SECURE COMMUNICATION PROTOCOL,” which was filed on Mar. 6, 2008.

### TECHNICAL FIELD

This disclosure relates in general to communication networks, and more particularly to a method and system for protecting data with a secure communication protocol.

### OVERVIEW

Communication networks, such as the Internet, provide communication services using an insecure framework. For example, the Internet uses a packet-switched network in which packets are often transmitted from source to destination using routers. Devices, such as sniffers, may intercept and analyze information contained in these packets.

### SUMMARY

According to one embodiment of the present disclosure, a computerized method includes receiving encrypted user data and encrypted gatekeeper header data from a sender appliance. The encrypted user data is encrypted according to a receiver encrypting key. The encrypted gatekeeper header data is encrypted according to a gatekeeper encrypting key. The computerized method also includes identifying a receiver address by decrypting the encrypted gatekeeper header data according to a gatekeeper decrypting key. The computerized method further includes generating, by a computer, encrypted receiver header data according to the receiver encrypting key. The computerized method further includes transmitting, according to the identified receiver address, the encrypted user data and encrypted receiver header data to a receiver appliance.

Technical advantages of particular embodiments of the present disclosure include security improvements to communication networks, such as the Internet. For example, the Internet exposes user data, protocol data, and routing data, which enables tampering. The present disclosure is compatible with Internet Protocol (IP) technology and may be used to secure such user data and gatekeeper header data to protect the data from tampering.

Another technical advantage of particular embodiments of the present disclosure includes a secure protocol that provides reliable user management. For example, the present disclosure may provide user identification, individual user access control, and enable licensing of users.

Another technical advantage of particular embodiments of the present disclosure includes a secure protocol that provides enhanced security measures. For example, the secure protocol may exercise an emergency shutdown whereby the gatekeeper router can shut down an entire network in response to a single command. As another example, sharing and storage of encrypting and decrypting keys is managed to avoid sharing of keys over the Internet. As another example, encrypted user data may be subject to decryption by a network administrator to investigate any security incident. As another example, direct communication between components of the network may be prohibited through the use of a central control.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram illustrating one embodiment of a secure communication network according to the teachings of the present disclosure;

FIG. 2 is a block diagram illustrating one embodiment of fixed-length packets that may be transmitted between a sender appliance, a gatekeeper, and a receiver appliance; and

FIG. 3 is a flowchart illustrating example acts associated with a computerized method that may be performed to protect data in the communication network of FIG. 1.

### DETAILED DESCRIPTION OF THE DISCLOSURE

Although the Internet has developed into a ubiquitous form of communication, it operates using an insecure network in which Internet Protocol (IP) packet data may be of unknown origin and in which IP packet data is visible to unidentified personnel without a need-to-know. To solve this problem, various secure protocols have been developed. For example, the SSL protocol is a type of secure protocol that encrypts user data prior to transmission over the Internet. User data refers to any suitable data to be transferred in the payload of a packet. SSL is susceptible to tampering because routing data of transmitted packets may be intercepted and analyzed. Routing data refers to any suitable data to be transferred in the header of a packet, such as destination and source addresses.

According to one embodiment of the disclosure, a system and method are provided for protecting data with a secure communication protocol. This is effected, in one embodiment, by encrypting user data according to a receiver encrypting key and encrypting combined routing data and validation data in a gatekeeper header according to a gatekeeper encrypting key. A gatekeeper router, also referred to as a gatekeeper, receives the encrypted user data and encrypted gatekeeper header data from a sender appliance. The gatekeeper router decrypts the gatekeeper header and identifies a receiver address. The gatekeeper router generates receiver header data and encrypts this header according to the receiver encrypting key. The gatekeeper router transmits, according to the identified receiver address, the encrypted user data and encrypted receiver header data to a receiver appliance. Thus, the data is protected because unencrypted user data and protocol data are not transmitted, and source address and destination address are not simultaneously transmitted.

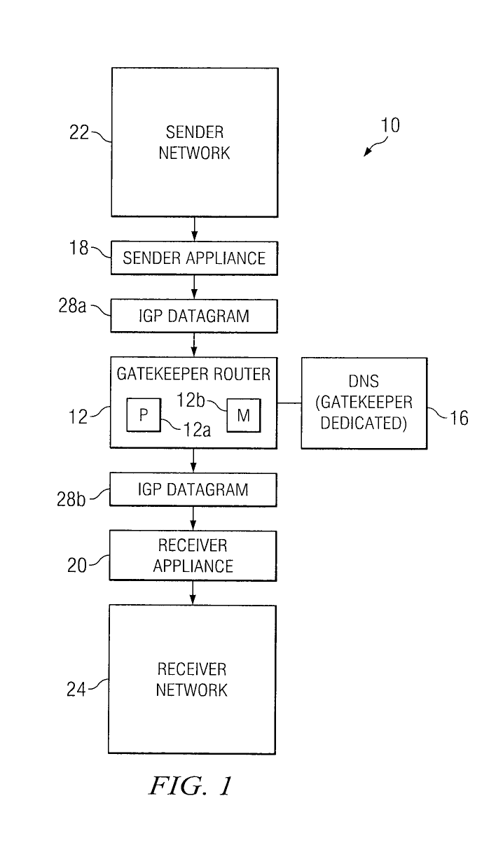

FIG. 1 illustrates one embodiment of a communication network 10 that protects data with a secure communication protocol. Communication network 10 includes a gatekeeper router 12, a domain name server (DNS) 16, a sender appliance 18, and a receiver appliance 20.

According to one embodiment of the disclosure, gatekeeper router 12 may store a gatekeeper encrypting key, a gatekeeper decrypting key, and a receiver encrypting key. Sender appliance 18 and receiver appliance 20 may store the gatekeeper encrypting key and a bit scramble code. Receiver appliance 20 may store a receiver decrypting key. Sender appliance 18 encrypts user data according to the receiver encrypting key and encrypts gatekeeper header data according to the gatekeeper encrypting key. A gatekeeper encrypting key and a receiver encrypting key may refer to a public encryption key. A gatekeeper decrypting key and a receiver decrypting key may refer to a private encryption key. Encryption of user data with the receiver encrypting key provides secure transmission of user data through communication network 10. Encryption of gatekeeper header data with the gatekeeper encrypting key provides secure transmission of gatekeeper header data through communication network 10. Implementing secure encryption keys for particular user data facilitates secure communications and reliable user management. User management may include, as examples, user identification, individual user access control, and licensing of users.

According to one embodiment of the disclosure, encryption keys may be distributed in communication network 10. For example, the receiver encrypting key may be distributed by gatekeeper dedicated DNS 16 to sender appliance 18. As yet another example, the gatekeeper encrypting and decrypting keys and receiver encrypting and decrypting keys may be generated by any suitable device in communication network 10. As yet another example, the receiver encrypting key is added on command to the gatekeeper router 12 and the receiver decrypting key may not be distributed to gatekeeper router 12, thus providing user data privacy through gatekeeper router 12.

A bit scramble code may be used to scramble data before the data is encrypted, according to one embodiment of the disclosure. For example, the bit scramble code may be distributed in the same manner as encrypting and decrypting keys. The bit scramble code may be used to scramble user data at sender appliance 18 before the user data is encrypted.

Domain name server (DNS) 16 may distribute encrypting keys and a bit scramble code of receiver appliance 20, and typical DNS data, such as IP addresses, of network interface cards (NIC) on receiver network, to members of communication network 10, according to one embodiment of the disclosure. Receiver appliance IP addresses may not be made publicly available and therefore the actual receiver appliance IP addresses may remain unknown to sender appliance 18. For example, during generation of a packet, sender appliance 18 may use an IP address acquired from the DNS for uniquely addressing a NIC on the receiver network behind receiver appliance 20. Gatekeeper router 12 may use the destination IP address of a NIC on the receiver network to look up the actual IP address of receiver appliance 20. Thus, sender appliance 18 may not know the actual IP address of receiver appliance 20 and receiver appliance 20 may not know the actual IP address of sender appliance 18.

According to one embodiment of the disclosure, sender appliance 18 may process IP messages bound for a receiver network and send an Internet Gatekeeper Protocol (IGP) datagram 28 to gatekeeper router 12. For example, sender appliance 18 may detect routable IP packets from a sender network 22. Sender appliance 18 may build a first in first out (FIFO) queues of packets collated by destination receiver network IP address. Sender appliance 18 may compress the packets in the FIFO queue. Sender appliance 18 may scramble the packets by applying a scramble code to the compressed packets. Sender appliance 18 may encrypt the user data according to the receiver encrypting key and the gatekeeper header data according to the gatekeeper encrypting key. Sender appliance 18 may fragment the compressed and encrypted packets, considering the gatekeeper header sizes, to ensure that the size of the largest outbound IGP datagram 28 is below the IP network fragmentation limit. Sender appliance 18 may generate IGP datagram 28 by adding the gatekeeper header and IP header with gatekeeper destination IP address to each fragment and transmit IGP datagram 28a to gatekeeper router 12.

According to one embodiment of the disclosure, gatekeeper router 12 may receive and process IGP datagram 28a before transmitting IGP datagram 28b to receiver appliance 20. Gatekeeper router 12 may decrypt the gatekeeper header data according to the gatekeeper decrypting key. Gatekeeper router 12 may validate IGP datagram 28a from sender appliance 18. For example, gatekeeper router 12 may validate a private sender identifier, an age authentication time stamp, uniqueness of a packet sequence number, or perform any other suitable verification of IGP datagram 28a, such as performing a cyclic redundancy check (CRC) computation of user data and comparing it with the user data CRC provided in the gatekeeper header data to verify that the gatekeeper header data corresponds to the user data. Gatekeeper router 12 may log packet data from sender IGP datagram 28a. Gatekeeper router 12 may look up a receiver appliance 20 IP address for the IP header based on the destination IP address contained in the decrypted gatekeeper header data and transmit IGP datagram 28b to receiver appliance 20.

According to one embodiment of the disclosure, receiver appliance 20 may receive and process IGP datagram 28b from gatekeeper router 12. Receiver appliance 20 may validate IGP datagram 28b from gatekeeper router 12. For example, receiver appliance 20 may validate the private receiver identifier, the age authentication time stamp, uniqueness of a sequence number, or perform any other suitable verification of IGP datagram 28b, such as performing a CRC computation of user data and compare it with the user data CRC provided in the receiver header data to verify that the receiver header data corresponds to the user data. Receiver appliance 20 may the remove IP header and receiver header from each fragment and reassemble fragments of IGP datagram 28. Receiver appliance 20 may decrypt the reassembled packets using the receiver decrypting key. Receiver appliance 20 may descramble the packets using the receiver appliance 20 bit scramble code, inflate the sender network IP packets and place inflated IP packets on communication network 10 for transmission to receiver network 24.

In operation of an example communication session in communication network 10, sender appliance 18 encrypts user data from sender network 22 according to a receiver encrypting key, and generates encrypted gatekeeper header data according to a gatekeeper encrypting key. Sender appliance 18 transmits an IGP datagram 28 with the user data and gatekeeper header data to gatekeeper router 12. Gatekeeper router 12 identifies a receiver address by decrypting the encrypted gatekeeper header data according to the gatekeeper decrypting key. Gatekeeper router 12 transmits, according to the identified receiver appliance IP address, the encrypted user data and encrypted receiver header data in IGP datagram 28b to receiver appliance 20.

Gatekeeper router 12, DNS server 16, sender appliance 18, and receiver appliance 20 may each include any type of suitable computing system that executes instructions stored in a memory, according to one embodiment of the disclosure. Examples of suitable computing systems include personal computers, workstations, personal digital assistants (PDAs), mainframe computers, and distributed computing systems, such as computer clusters. For example, in the illustrated embodiment, gatekeeper router 12 includes a processor (P) 12a that may refer to any suitable device operable to execute instructions and manipulate data to perform operations for gatekeeper router 12. Processor 12a may include, for example, any type of central processing unit (CPU). As another example, in the illustrated embodiment, gatekeeper router 12 includes memory device (M) 12b that may refer to any suitable device operable to store and facilitate retrieval of data, and may comprise Random Access Memory (RAM), Read Only Memory (ROM), a NAND type flash memory, a magnetic drive, a disk drive, a Compact Disk (CD) drive, a Digital Video Disk (DVD) drive, removable media storage, any other suitable data storage medium, or a combination of any of the preceding. According to one embodiment of the disclosure, any suitable logic, such as a program of instructions, may be embodied in memory device (M) 12b and may be operable to perform various functions including the operations described with reference to gatekeeper router 12.

According to one embodiment of the disclosure, the functions of gatekeeper router 12 and DNS server 16 may be implemented on individually distinct computing systems and may be combined in one or more computing systems. In the illustrated embodiment, sender appliance 18 and receiver appliance 20 communicate user data to and from sender network 22 and receiver network 24. In other embodiments, sender appliance 18 and receiver appliance 20 may be configured to communicate information over communication network 10 using any suitable computing configuration.

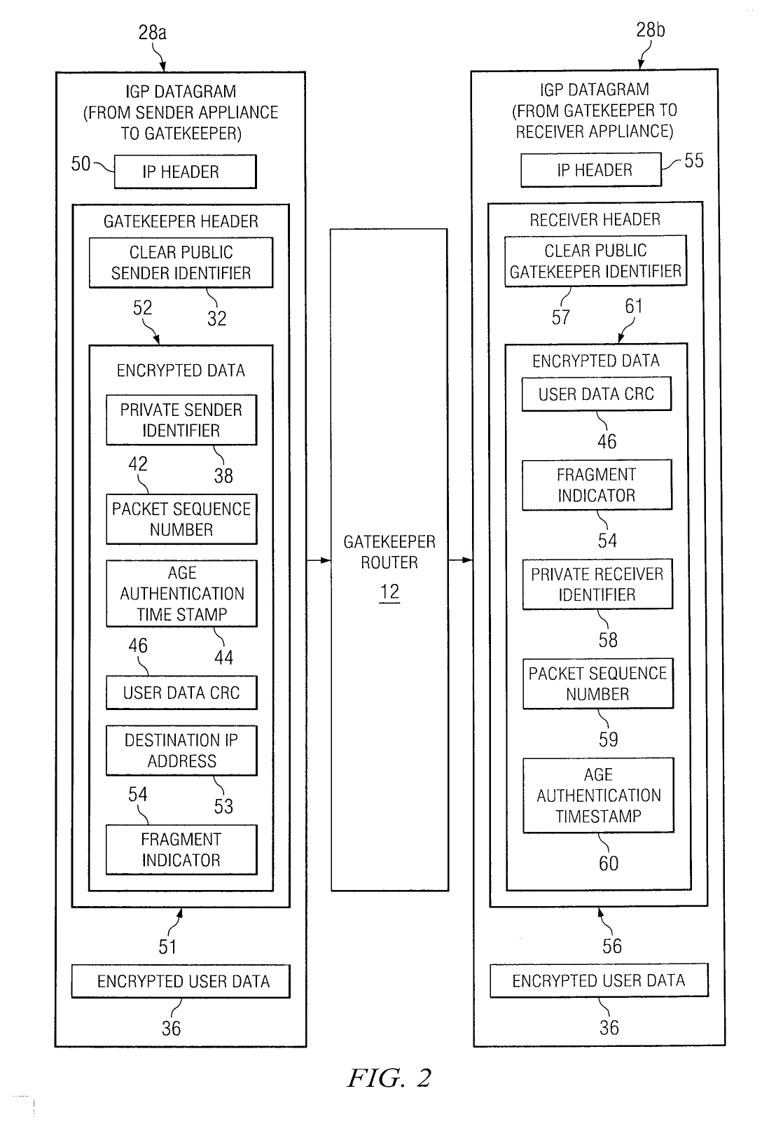

According to one embodiment of the disclosure, communication between sender appliance 18, receiver appliance 20, gatekeeper router 12, and DNS server 16 may be provided using fixed-length IGP datagram 28 according to a user datagram protocol (UDP). IGP datagram 28 having a fixed length may provide enhanced protection from tampering in some embodiments by simplifying gatekeeper and receiver appliance processing of incoming datagrams. Other transport layer protocols, such as the transport control protocol (TCP) may generate variable length packets according to the type of message conveyed subject to vulnerable exposed protocols which provide the opportunity to tamper with the protocol and IP network fragmentation which provides the opportunity to tamper with packet re-assembly. Additional details of IGP datagram 28 are described below with reference to FIG. 2.

FIG. 2 illustrates an embodiment of one particular IGP datagram 28a that may be transmitted from sender appliance 18 to gatekeeper router 12 and another embodiment of another IGP datagram 28b that may be transmitted from gatekeeper router 12 to receiver appliance 20. IGP datagram 28a includes a public sender identifier 32, a gatekeeper header portion 51, and a user data portion 36. Public sender identifier 32 is used by gatekeeper router 12 to look up and verify the corresponding private identifier 38. Gatekeeper header encrypted data 52 is decrypted using the gatekeeper decrypting key and descrambled using the sender appliance scramble code. Gatekeeper router 12 compares the clear public sender identifier 32 and private identifier 38 as part of the validation process. Once the gatekeeper header 51 is completely validated, gatekeeper router 12 extracts the destination IP address 53 from the gatekeeper header encrypted data 52 provided by the sender appliance and uses it to look up the receiving IP address for the IP header 55 and the private receiver identifier 58. Receiver header 56 portion may be encrypted according to the receiver encrypting key prior to transmission to receiver appliance 20. User data portion 36 is copied from IGP datagram 28a to IGP datagram 28b unmodified. Fragment indicator 54 is copied from IGP datagram 28a to IGP datagram 28b headers unmodified. User data CRC 46 is copied from IGP datagram 28a to IGP datagram 28b headers unmodified.

According to one embodiment of the disclosure, gatekeeper header encrypted data portion 52 includes a private sender identifier 38, a packet sequence field 42, an age authentication time stamp field 44, a sender network IP packet destination IP address 53, a fragment indicator 54, and a user data CRC field 46. Packet sequence field 42 may be used to indicate the sequence of IGP datagram 28a that may have been fragmented by sender appliance 18. Age authentication time stamp field 44 may include a numerical value for age authentication of IGP datagram 28a by gatekeeper router 12. User data CRC field 46 may include a CRC numerical value calculated from the user data for verifying that the user data corresponds to the gatekeeper header encrypted data 52.

According to one embodiment of the disclosure, gatekeeper router 12 may validate IGP datagram 28a. For example, gatekeeper router 12 may verify a match between public sender identifier 32 and private sender identifier 38. As another example, gatekeeper router 12 may verify that packet sequence field 42 is a unique packet sequence number. As another example, gatekeeper router 12 may verify that age authentication time stamp field 44 has an age within an acceptable range. As yet another example, gatekeeper router 12 may perform a CRC computation.

According to one embodiment of the disclosure, IGP datagram 28 may be dropped to maintain security of the communication network. For example, gatekeeper router 12 may drop IGP datagram 28a if IGP datagram 28a fails a validation test. As another example, receiver appliance 20 may drop IGP datagram 28b if IGP datagram 28b fails a validation test.

Gatekeeper router 12 processes gatekeeper header 51 to provide IP header 55, receiver header 56, appends user data 36 and sends the outgoing IGP datagram 28b to receiver appliance 20, according to one embodiment of the disclosure. For example, gatekeeper router 12 may process gatekeeper header encrypted data portion 52 to look up private sender identifier 38 and use destination IP address 53 to look up receiver appliance destination address for IGP datagram 28b IP header 55 and private receiver identifier 58. Thus, sniffing of IGP datagram 28b while in transit from gatekeeper router 12 to receiver appliance 20 may not reveal the source IP address of the sender appliance. As another example, gatekeeper router 12 may encrypt the sender address of the sender appliance. By encrypting the sender IP packets, in the user data, neither the source IP address nor the destination IP address of the IP packets from the sender network may be readily decipherable while IGP datagram 28b is transmitted from gatekeeper router 12 to receiver appliance 20.

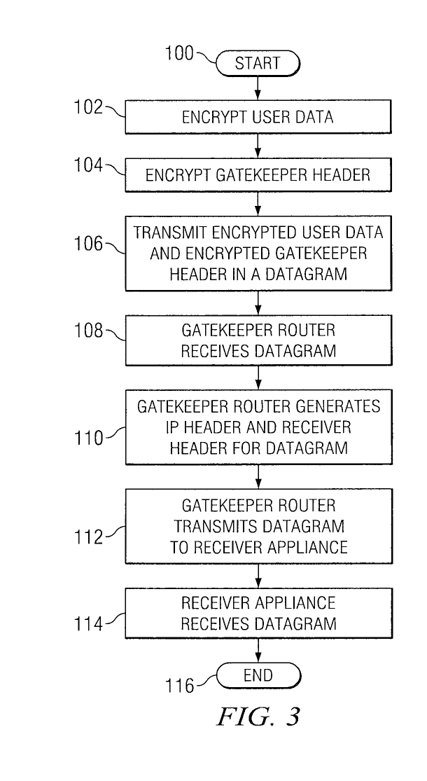

FIG. 3 is a flowchart illustrating example acts associated with a computerized method that may be performed to protect data in communication network 10 of FIG. 1. The example acts may be performed by gatekeeper router 12, sender appliance 18, and receiver appliance 20, as discussed above with reference to FIGS. 1 and 2, or by any other suitable device.

At step 100, the process is initiated. At step 102, user data is encrypted according to a receiver encrypting key. In one embodiment, the user data may be scrambled prior to encryption. Scrambling of user data may reduce effectiveness of deciphering algorithms performed on transmitted packets. In another embodiment, user data may be asymmetrically encrypted in which the receiver encrypting key is a public encryption key.

At step 104, the gatekeeper header 51 is generated and the encrypted data 52 is encrypted according to a gatekeeper encrypting key. In one embodiment, the gatekeeper header encrypted data 52 may include a destination IP address 53 of the sender network IP packets. In one embodiment, the sender network IP packet destination IP address 53 is asymmetrically encrypted with the encrypted data 52 in which gatekeeper encrypting key is a public encryption key. In another embodiment, other routing data, such as a packet sequence field 42, an age authentication field 44, and a CRC field 46, a fragment indicator 54 and a private sender identifier 38 may be encrypted.

At step 106, the IP header 50, encrypted user data 36, clear public sender identifier 32 and the encrypted gatekeeper header 52 are transmitted to a gatekeeper router. In one embodiment, the IP header 50, clear public sender identifier 38, encrypted user data 36 and the encrypted gatekeeper header 52 may be encapsulated in fixed-length packets, such as UDP packets. Messages from the sender appliance to the gatekeeper having packets of this type may be difficult to decipher due to their fixed-length format and encrypted validation, association and routing data.

At step 108, the gatekeeper router receives the datagram from the sender appliance. The IP header 50 is discarded. The encrypted data 52 is decrypted using the gatekeeper decrypting key. In one embodiment in which the destination IP address 53 was encrypted by asymmetric encryption, the encrypted destination IP address 53 may be decrypted according to a gatekeeper decrypting key. The gatekeeper router may not have access to the receiver decrypting key. By inhibiting access to the receiver decrypting key by the gatekeeper router, privacy of the user data may be protected from potential security attacks originating at the gatekeeper.

At step 110, the gatekeeper router builds an outgoing UDP IP header 55 using the receiver appliance public internet IP address looked up using the sender network IP packet destination IP address 53 from the decrypted gatekeeper header 52. The gatekeeper router constructs a receiver header 56 including clear public receiver identifier 57, encrypted private receiver identifier 58, encrypted packet sequence number 59, encrypted fragment indicator 54, age authentication time stamp 60 and user data CRC 46 copied from the gatekeeper header 51. By encrypting the private receiver identifier 58, the private sender identifier 58 may not be readily decipherable while the datagram is transmitted from the gatekeeper to the receiver appliance.

At step 112, the gatekeeper router transmits the IP header 55, receiver header 56, including encrypted data 61, and encrypted user data 36 to the receiver appliance according to the gatekeeper constructed IP header 55 including the receiver appliance destination IP address. The source IP address in user data and the source network IP packets are encrypted so that the origin of the IP packets may not be readily obtained. The source IP address of the sender appliance is not included in the datagram addressed to the receiver appliance so that the sender appliance origin of the datagram user data may not be readily obtained. Thus, secure communication may be provided by not transmitting an IP message that simultaneously includes unencrypted destination and source IP addresses.

At step 114, the receiver appliance receives the IP header 55, receiver header 56 with encrypted data 61 and user data 36. The receiver appliance 20 decrypts the receiver header 56 encrypted data 61 according to a receiver decrypting key, validates the receiver header 56 and decrypts the user data 36 according to a receiver decrypting key. In one embodiment in which the user data has been scrambled, the receiver appliance may unscramble the user data following its decryption. The receiver header 56 sequence number 59 may be used to verify proper sequencing of packets and other receiver header data may be used to perform other verification checks, such as age authentication, private receiver identifier authentication, and CRC computations. At step 116, the process is ended.

Modifications, additions, or omissions may be made to the previously described method without departing from the scope of the disclosure. The method may include more, fewer, or other steps. For example, the sender appliance 18 may communicate with multiple receiver appliances 20 through gatekeeper router 12 in a hub-spoke network fashion.

Although several embodiments have been illustrated and described in detail, it will be recognized that substitutions and alterations are possible without departing from the spirit and scope of the present disclosure, as defined by the following claims.

What is claimed is:

1. A computerized method, comprising:
receiving encrypted user data and encrypted gatekeeper header data from a sender appliance, the encrypted user data being encrypted according to a receiver encrypting key, the encrypted gatekeeper header data being encrypted according to a gatekeeper encrypting key;
identifying a receiver address by decrypting the encrypted gatekeeper header data according to a gatekeeper decrypting key;
generating, by a computer, encrypted receiver header data according to the receiver encrypting key; and
transmitting, according to the identified receiver address, the encrypted user data and encrypted receiver header data to a receiver appliance.

2. The computerized method of claim 1, wherein the encrypted user data comprises scrambled user data.

3. The computerized method of claim 1, wherein the encrypted user data and encrypted gatekeeper header data are encapsulated in one or more packets.

4. The computerized method of claim 1, further comprising performing a cyclic redundancy check (CRC) computation on the encrypted user data.

5. The computerized method of claim 1, further comprising modifying the encrypted gatekeeper header data.

6. The computerized method of claim 1, wherein the encrypted user data comprises asymmetrically encrypted user data.

7. The computerized method of claim 1, wherein the encrypted gatekeeper header data comprises asymmetrically encrypted gatekeeper header data.

8. A system, comprising:
a processor; and
a storage device embodying a program of instructions operable, when executed on the processor, to:
receive encrypted user data and encrypted gatekeeper header data from a sender appliance, the encrypted user data being encrypted according to a receiver encrypting key, the encrypted gatekeeper header data being encrypted according to a gatekeeper encrypting key;
identify a receiver address by decrypting the encrypted gatekeeper header data according to a gatekeeper decrypting key;
generate encrypted receiver header data according to the receiver encrypting key; and
transmit, according to the identified receiver address, the encrypted user data and encrypted receiver header data to a receiver appliance.

9. The system of claim 8, wherein the encrypted user data comprises scrambled user data.

10. The system of claim 8, wherein the encrypted user data and encrypted gatekeeper header data are encapsulated in one or more packets.

11. The system of claim 8, wherein the program of instructions is further operable to perform a cyclic redundancy check (CRC) computation on the encrypted user data.

12. The system of claim 8, wherein the program of instructions is further operable to modify the encrypted gatekeeper header data.

13. The system of claim 8, wherein the encrypted user data comprises asymmetrically encrypted user data.

14. The system of claim 8, wherein the encrypted gatekeeper header data comprises asymmetrically encrypted gatekeeper header data.

15. Computer-readable media encoded with logic, the logic being operable, when executed on a processor, to:
receive encrypted user data and encrypted gatekeeper header data from a sender appliance, the encrypted user data being encrypted according to a receiver encrypting key, the encrypted gatekeeper header data being encrypted according to a gatekeeper encrypting key;
identify a receiver address by decrypting the encrypted gatekeeper header data according to a gatekeeper decrypting key;
generate encrypted receiver header data according to the receiver encrypting key; and
transmit, according to the identified receiver address, the encrypted user data and encrypted receiver header data to a receiver appliance.

16. The logic of claim 15, wherein the encrypted user data comprises scrambled user data.

17. The logic of claim 15, wherein the encrypted user data and encrypted gatekeeper header data are encapsulated in one or more packets.

18. The logic of claim 15, wherein the logic is further operable to perform a cyclic redundancy check (CRC) computation on the encrypted user data.

19. The logic of claim 15, wherein the logic is further operable to modify the encrypted gatekeeper header data.

20. The logic of claim 15, wherein the encrypted user data comprises asymmetrically encrypted user data.
